(19) United States
(12) Patent Application Publication
(10) Pub. No.: US 2025/0286088 A1
(43) Pub. Date: Sep. 11, 2025

(54) HUMIDIFIER

(71) Applicant: MAHLE International GmbH, Stuttgart (DE)

(72) Inventor: Samuel Kohler, Weil im Schoenbuch (DE)

(21) Appl. No.: 19/076,814

(22) Filed: Mar. 11, 2025

(30) Foreign Application Priority Data
Mar. 11, 2024 (DE) 102024106809.4
Jan. 30, 2025 (DE) 102025103485.0

(51) Int. Cl. H01M 8/04119; H01M 8/0273; H01M 8/04089

(52) U.S. Cl. CPC H01M 8/04149; H01M 8/0273; H01M 8/04104

(57) ABSTRACT

A humidifier for humidifying dry fresh air using humid exhaust air may include a housing and a humidifier block disposed in the housing. The housing may include a fresh air inlet for supplying dry fresh air, a fresh air outlet for evacuating humidified fresh air, an exhaust air inlet for supplying humid exhaust air, and an exhaust air outlet for evacuating dehumidified exhaust air. The humidifier block may include a membrane stack through which a fresh air flow and an exhaust air flow are flowable for humidifying the dry fresh air via the humid exhaust air. The membrane stack may include membranes impermeable to air and permeable to moisture. The humidifier block may include two end plates that are respectively braced against a respective end face of the membrane stack via at least one elastic seal preloaded in a lengthwise direction of the humidifier block.

### CROSS-REFERENCE TO RELATED APPLICATIONS

This application claims priority to German Patent Application No. DE 102024106809.4, filed on Mar. 11, 2024, and German Patent Application No. DE 102025103485.0, filed on Jan. 30, 2025, the contents of both of which are hereby incorporated by reference in their entirety.

### TECHNICAL FIELD

The present invention relates to a humidifier for humidifying fresh dry air using humid exhaust air, in particular of a fuel cell system.

### BACKGROUND

Such a humidifier typically has a housing and a humidifier block. The housing encloses a housing interior and has a fresh air inlet for supplying dry fresh air, a fresh air outlet for evacuating humidified fresh air, an exhaust air inlet for supplying humidified exhaust air, and an exhaust air outlet for evacuating humidified exhaust air. The humidifier block is inserted into the housing interior and comprises a membrane stack through which an exhaust air flow and a fresh air flow can separately flow to humidify the fresh air by means of the exhaust air flow, and which is formed with membranes impermeable to air and permeable to moisture. The membrane stack has two end faces located opposite one another in a lengthwise direction of the block. The humidifier block has two end plates that are the respective arranged on one of the end faces.

To prevent leakage, the end plates are sealed against the end face. A sealing joining technology, such as adhesive bonding, can be used in this case. However, it has been shown that these joints or adhesive bonds are subjected to mechanical stresses when the humidifier is in operation and are therefore subjected to high wear. This can lead to damage or loosening of the adhesive bond. The sealing effect is reduced if the adhesive bond is damaged or loosened, which can result in undesirable leakage between the fresh air flow and the exhaust air flow. This reduces the efficiency of the humidifier.

### SUMMARY

The present invention addresses the problem of specifying an improved or at least a different embodiment for such a humidifier, characterized by high wear resistance, preferably with a high efficiency goal, and which in particular aims to avoid leakage in the area of the end plates.

The invention solves this problem with the scope of the independent claim(s). Advantageous embodiments are the scope of the dependent claim(s).

The invention is based on the general idea of bracing the respective end plate against the respective end face by means of at least one elastic seal, wherein the elastic seal is elastically preloaded in the lengthwise direction of the block. The invention takes advantage of the knowledge that a differential pressure is created in the housing between the fresh air and the exhaust air when the humidifier is in operation, which leads to elastic deformation of the end plates. In conventional designs—which operate with an adhesive bond between the respective end plate and the respective end face—this elastic deformation of the end plates creates a high mechanical load on the respective adhesive bond. By using a preloaded elastic seal in place of an adhesive bond—as proposed by the invention—the seal can conform to the elastic deformation of the end plate without exerting additional stress on the seal. When the humidifier is in operation, the deformation of the end plate induced by the differential pressure relieves the load on the seal such that the seal can conform to a relative movement between the end plate and the associated end face. The seal can then maintain its sealing effect. The tight connection or coupling between the respective end plate and the associated end face is thus decoupled from wear such that the humidifier presented here is characterized in particular by increased wear resistance. This also helps to avoid disadvantageous leaks around the end plates, which increases the efficiency of the humidifier.

In particular when the humidifier is used in a fuel cell system, the moisture is water or water vapor. The membranes are permeable to moisture and/or water while substantially impermeable to air. In the present context, the terms “moist”, “humid”, “dry”, “dehumidified”, and “humidified” are to be understood as relative terms. The dehumidified exhaust air therefore contains less moisture than the humid exhaust air, and the humidified supply air contains more moisture than the dry supply air.

An embodiment wherein the respective end plate is spaced apart from the respective end face in the lengthwise direction of the block is particularly advantageous. The end face of the membrane stack, which can in particular be formed by the first or last membrane of the membrane stack, can in this manner additionally be used for incident flow by fresh air or exhaust air, which increases the efficiency of the humidifier. This measure also completely decouples, and thus relieves the mechanical load of, the membrane stack from the deformation of the respective end plate when the humidifier is in operation. This reduces wear and facilitates the longevity of the membrane stack.

When the humidifier is in operation, differential pressure can form in the housing between the fresh air flow and the exhaust air flow. Typically, the pressure in the fresh air flow is higher than in the exhaust air flow. According to an advantageous embodiment, the respective end plate can-outside of the respective seal-have a distance in the lengthwise direction of the block from the respective end face in the lengthwise direction of the block that is greater by an elongation dimension when differential pressure is applied or less by a compression dimension in the lengthwise direction of the block when differential pressure is absent. In other words, when the humidifier is in operation, the respective end plate is deformed by the differential pressure such that its distance from the associated end face increases or decreases, depending on the differential pressure. Furthermore, the respective seal can now, in a relaxed state, be adapted to be larger in the lengthwise direction of the block by a preload dimension than in a preloaded installation state wherein said seal bridges the distance between the respective end plate and the respective end face when differential pressure is absent. The differential pressure is absent in particular when the humidifier is not in operation. Moreover, the respective seal can be adapted such that the preload dimension is greater than the elongation dimension of the respective end plate. As a result, when the end plate is subject to elongation deformation, the seal is still sufficiently preloaded to produce the desired sealing effect even with the greatest deformation of the end plate that can occur when the humidifier is operating as intended. Only in the event of an overload, which does not occur when the humidifier is operated as intended, can the end plate be deformed to move away from the associated end face to such an extent that the elastic seal is unable to compensate for this movement. Although this overload then creates a leak that temporarily reduces the efficiency of the humidifier, it nevertheless provides pressure equalization, which reduces the load on, and deformation of, the end plate. By contrast, the deformation of the seal and its preload increases when the end plate is subject to compression deformation, thus maintaining the sealing effect. The elasticity of the seal is suitably selected such that even on the greatest deformation of the end plate that can occur when the humidifier is operated as intended, the compression of the seal remains in the elastic region, thus avoiding damage to the seal.

In the present context, the term “adaptation” is synonymous with the term “embodiment” and/or “arrangement”, the phrase “adapted such that” is therefore synonymous with the phrase “embodied and/or arranged such that”.

Expediently, the distance between the respective end plate and the associated end face as well as the deformation of the seal in a central region of the end plate transverse to the lengthwise direction of the block are considered, since this is where the pressure differential is expected to cause the greatest deformation of the end plate.

In an advantageous embodiment, the respective seal can be adapted as an I-seal, characterized by an elongated cross-section that is with respect to its lengthwise direction aligned parallel to the lengthwise direction of the block. The seal adapted as an I-seal is preloaded in the lengthwise direction of the block in that it is compressed, i.e., pressed together or tamped, in the lengthwise direction of the block. If the end plate is deformed when the humidifier is in operation, the compressed seal can expand in the lengthwise direction of the block and still maintain the desired sealing effect.

In an alternative embodiment, the respective seal can be adapted as a lip seal having a holding foot held on the respective end plate or end face and a sealing contour abutting the respective end face or end plate. The seal adapted as a sealing lip can now be preloaded in the lengthwise direction of the block by being elastically deformed by bending about a bending axis oriented transversely to the lengthwise direction of the block. If the end plate deforms when the humidifier is in operation, the elastically deformed sealing lip can conform to a deformation-induced relative movement of the end plate with respect to the end face, while continuing to maintain the desired sealing effect.

In an advantageous further embodiment, the seal adapted as a sealing lip can be arranged such that a differential pressure between the fresh air flow and the exhaust air flow amplifies the preloaded contact of the respective seal on the end face or on the respective end plate. This can improve the sealing effect. Alternatively, the differential pressure can reduce the preload.

The respective seal can expediently be adhesive-bonded to the respective end plate and to the respective end face. This simplifies the handling of the humidifier block. In particular, the seal adapted as an I-seal can be adhesive-bonded to the end plate and also to the end face.

Another embodiment can by contrast provide that the respective seal abuts loosely on the respective end plate and also on the respective end face. This can simplify the manufacturing process of the humidifier block.

In another embodiment, the respective seal can be held on, or adhesive-bonded to, the respective end plate and can loosely abut the respective end face. Alternatively, the respective seal can be held on, or adhesive-bonded to, the respective end face and can loosely abut the respective end plate. This measure also simplifies the production and handling of the humidifier block. This embodiment is particularly suited for the seal adapted as a lip seal.

The membrane stack can be adapted to have two sides transversely facing away from one another in the lengthwise direction of the block, wherein the humidifier block has a sealing frame on the respective of these two sides that is arranged on the respective side circumferentially closed along the perimeter, and braces the humidifier block against the housing to form a seal. The respective sealing frame can now expediently also enclose the two end plates on the respective side. The respective sealing frame then connects the two end plates to the membrane stack to form a seal. In particular, the sealing frame can absorb the forces acting on the end plate when the humidifier is in operation such that no deformation of the end plate occurs, in particular in the region of the respective sealing frame. The elastically preloaded seal, which seals the respective end plate against the associated end face, then expediently extends from one sealing frame to the other sealing frame. When the humidifier is in operation, the respective end plate is deformed in an area between the two sealing frames. The greatest deformation then results substantially in the middle between the two sealing frames.

According to an advantageous embodiment, the respective sealing frame can comprise a circumferential side seal by which the respective sealing frame is braced against the housing to form a seal. By using a side seal, the functions of the sealing effect on the one hand and the holding effect on the other can be separated from one another such that the side seal generates the sealing effect against the housing, while the sealing frame generates the holding effect for holding the membrane stack in the housing.

The membrane stack can expediently include a fresh air inlet side fluidically connected to the fresh air inlet, a fresh air outlet side fluidically connected to the fresh air outlet, an exhaust air inlet side fluidically connected to the exhaust air inlet, and an exhaust air outlet side fluidically connected to the exhaust air outlet. Further, the membrane stack can form a fresh air path that fluidically connects the fresh air inlet side to the fresh air outlet side and an exhaust air path that fluidically connects the exhaust air inlet side to the exhaust air outlet side. Within the membrane stack, the fresh air path and the exhaust air path are fluidically separated from one another such that there is substantially no air exchange between the fresh air flow and the exhaust air flow, while moisture is transported by the exhaust air through the membranes to the fresh air.

According to a first embodiment, the fresh air inlet side and the exhaust air outlet side can face one another with respect to a transverse direction of the block that is transverse to the lengthwise direction of the block, while the exhaust inlet side and the fresh air outlet side can face one another with respect to a height direction of the block that is transverse to the lengthwise direction of the block and transverse to the transverse direction of the block. This results in a 90° deflection of the fresh air flow and a 90° deflection of the exhaust air flow within the membrane stack. This embodiment also achieves that the end plates are located on sides of the membrane stack, namely on the end faces, to which no inlet and no outlet are mapped. This simplifies the implementation of the seals on the end plates.

According to a second embodiment, the fresh air inlet side and the fresh air outlet side can face one another with respect to a transverse direction of the block that is transverse to the block lengthwise direction, while the exhaust air inlet side and the exhaust air outlet side can face one another with respect to a block height direction that is transverse to the block lengthwise direction and transverse to the block transverse direction. Thus, the fresh air flow and the exhaust air flow are routed linearly through the membrane stack, wherein the fresh air flow and the exhaust air flow intersect within the membrane stack. This embodiment likewise achieves that the end plates are located on sides of the membrane stack, namely on the end faces, to which no inlet and no outlet are mapped. This simplifies the implementation of the seals on the end plates.

According to a further embodiment, the respective end plate can have two end regions facing away from one another in the height direction of the block, wherein the respective end plate is braced against the respective end face by two elastic seals preloaded in the lengthwise direction of the block. The two seals are arranged on the respective end plate, respectively at one of the two end regions and extend lengthwise along the transverse direction of the block. In particular, the two seals can thus extend from one seal frame to the other seal frame. This design creates a comparatively large surface for incident fresh air or exhaust air between the respective end plate and the associated end face, which increases the efficiency of the humidifier.

According to an advantageous embodiment, the one sealing frame can be arranged on the fresh air inlet side, while the other sealing frame is arranged on the exhaust air outlet side in the aforementioned first embodiment and on the fresh air outlet side in the aforementioned second embodiment. This gives the humidifier a particularly easy to realize design. At the same time, this permits an adaptation wherein the preloaded seals arranged between the respective end plate and the associated end face can extend in the transverse direction of the block from one seal frame to the other seal frame. This realizes a complete seal in the respective end region.

The membranes within the membrane stack are expediently stacked together in the lengthwise direction of the block. In other words, a stacking direction wherein the membranes in the membrane stack are stacked together preferably extends parallel to the lengthwise direction of the block. In particular, the stacking direction can define the lengthwise direction of the block. Membranes form pockets or chambers, namely fresh air plenums through which fresh air flows, and exhaust air plenums through which exhaust air flows. The fresh air plenums and exhaust air plenums expediently alternate in stacking direction such that the fresh air flow and the exhaust air flow overlap within the membrane stack over a large surface area, but do not mix.

The membrane stack can be expediently adapted as a cuboid, which simplifies the manufacturing process of the membrane stack. The lengthwise direction of the block can be suitably larger than the transverse direction of the block and larger than the height direction of the block. In particular, the transverse direction of the block and the height direction of the block can be of equal size.

In another advantageous embodiment, the respective end plate can on an exterior side facing away from the membrane stack have at least one protruding, in particular straight, rib extending transversely to the lengthwise direction of the block, in particular parallel to the transverse direction of the block, which rib is braced against the housing. In this manner, the force generated by the differential pressure during operation and acting on the respective end plate can be at least partially absorbed by the housing to reduce deformation of the end plate.

Further important features and advantages of the invention are apparent from the dependent claims, from the drawings and from the associated description of the figures with reference to the drawings.

It is understood that the above-mentioned features and those yet to be explained below can be used not only in the combination indicated in the respective case, but also in other combinations or on their own, without deviating from the scope of the invention defined by the claims. The components of a superordinate unit, such as a device, an apparatus, or an arrangement, which are described separately, having been mentioned above or to be mentioned below, can represent separate components of this unit or can form integral regions or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

The drawings, each schematically, show in:

FIG. 1 shows an isometric view of a humidifier,

FIG. 2 shows an isometric cross section of the humidifier,

FIG. 3 shows an isometric lengthwise section of the humidifier,

FIG. 4 shows an isometric view of the humidifier with the housing shown transparently,

FIG. 5 shows an isometric view of a humidifier block in the region of an end plate in an unloaded state,

FIG. 6 shows a view in FIG. 5, but in a loaded state,

FIG. 7 shows a lengthwise section of the humidifier block in the region of the end plate in the unloaded state,

FIG. 8 shows a view in FIG. 7, but in the loaded state,

FIG. 9 shows an isometric view of the humidifier block in the region of the end plate in another embodiment,

FIG. 10 shows a view as in FIG. 1, but in a different embodiment,

FIG. 11 shows a view as in FIG. 2, but in a different embodiment,

FIG. 12 shows a view as in FIG. 3, but in a different embodiment,

FIG. 13 shows a view as in FIG. 4, but in a different embodiment.

### DETAILED DESCRIPTION

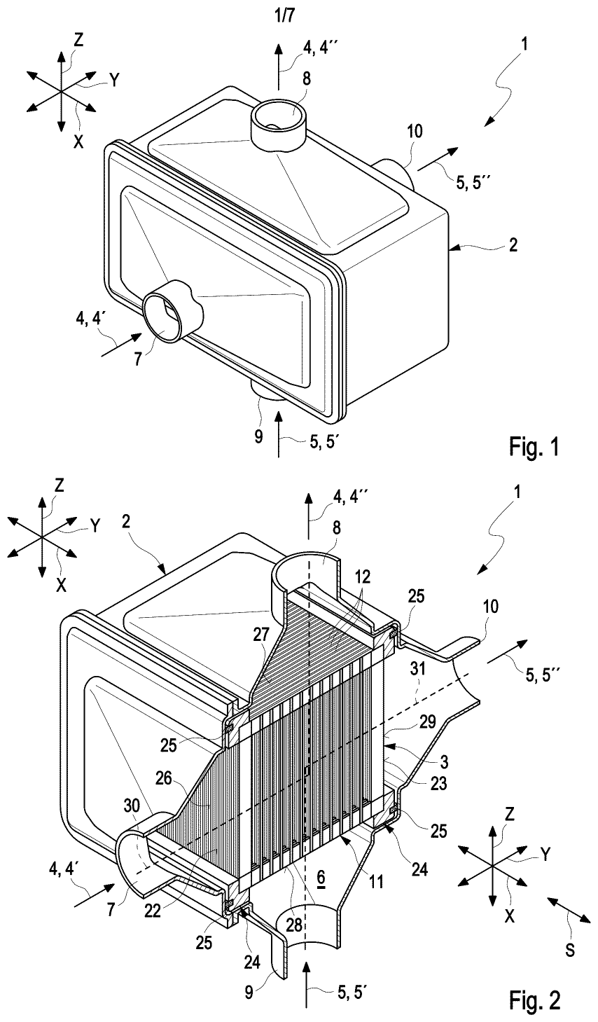

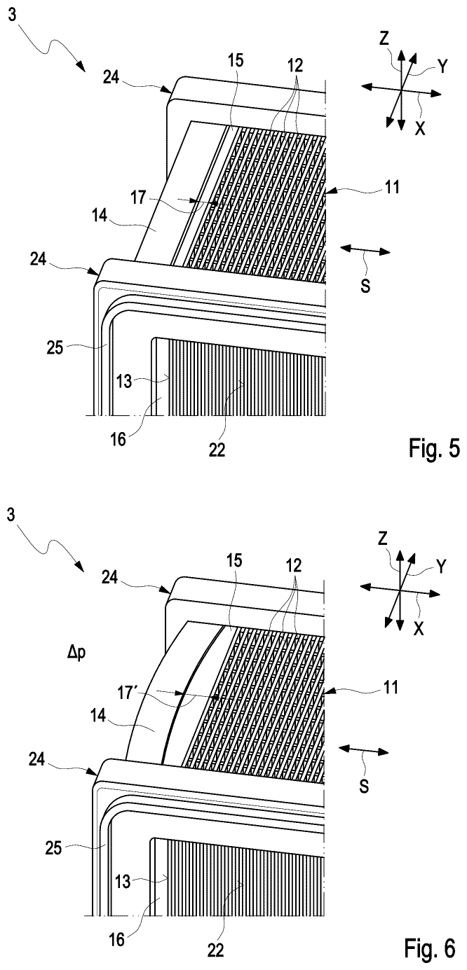

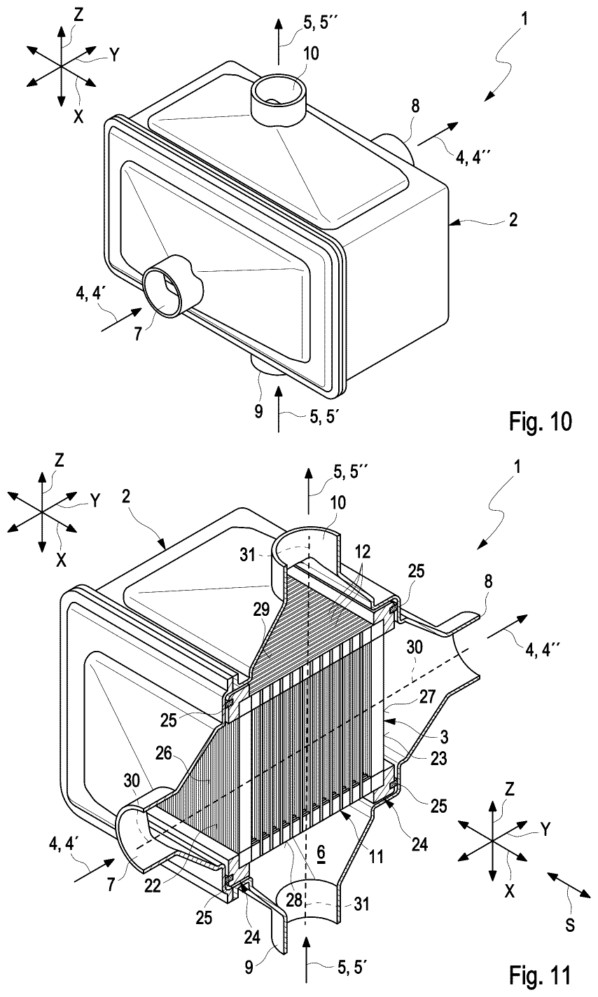

According to FIGS. 1 to 4 and 10 to 13, a humidifier 1 comprises a housing 2 as well as a humidifier block 3 (not shown in FIG. 1) arranged in the housing 2. In FIGS. 4 and 10, the housing 2 is shown transparently. In FIGS. 1 to 4 and 10 to 13, a fresh air flow 4 and an exhaust air flow 5, which flow through the housing 2 and the humidifier block 3 when the humidifier is in operation 1, are indicated by arrows. The fresh air flow 4 supplies dry fresh air 4′ to the humidifier 1 and evacuates humidified fresh air 4″ from the humidifier 1. The exhaust air flow 5 supplies the humidifier 1 with humid exhaust air 5′ and evacuates dehumidified exhaust air 5″ from the humidifier 1. The humidifier 1 is used for humidifying dry fresh air 4′ using humid exhaust air 5′ and can be used for this purpose in particular in a fuel cell system. In a fuel cell system, the humidifier 1 can for example humidify cathode fresh air using cathode exhaust air.

The housing 2 encloses a housing interior 6 and comprises a fresh air inlet 7 for supplying dry fresh air 4′, a fresh air outlet 8 for evacuating humidified fresh air 4″, an exhaust air inlet 9 for supplying humid exhaust air 5′, and an exhaust air outlet 10 for evacuating dehumidified exhaust air 5″.

The humidifier block 3 is inserted into the housing interior 6 and has a membrane stack 11. The fresh air flow 4 and the exhaust air flow 5 can flow through the membrane stack 11, which is formed using membranes 12 consisting of a membrane material impermeable to air and permeable to moisture. The membrane stack 11 is in this case adapted as a cuboid, wherein the humidifier block 3 defines a lengthwise direction of the block X, a transverse direction of the block Y and a height direction of the block Z that extend perpendicular to one another. Within the membrane stack 11, the membranes 12 can be stacked together in a stacking direction S that expediently extends parallel to the lengthwise direction of the block X. In this case, the stacking direction S can in particular define the lengthwise direction of the block X.

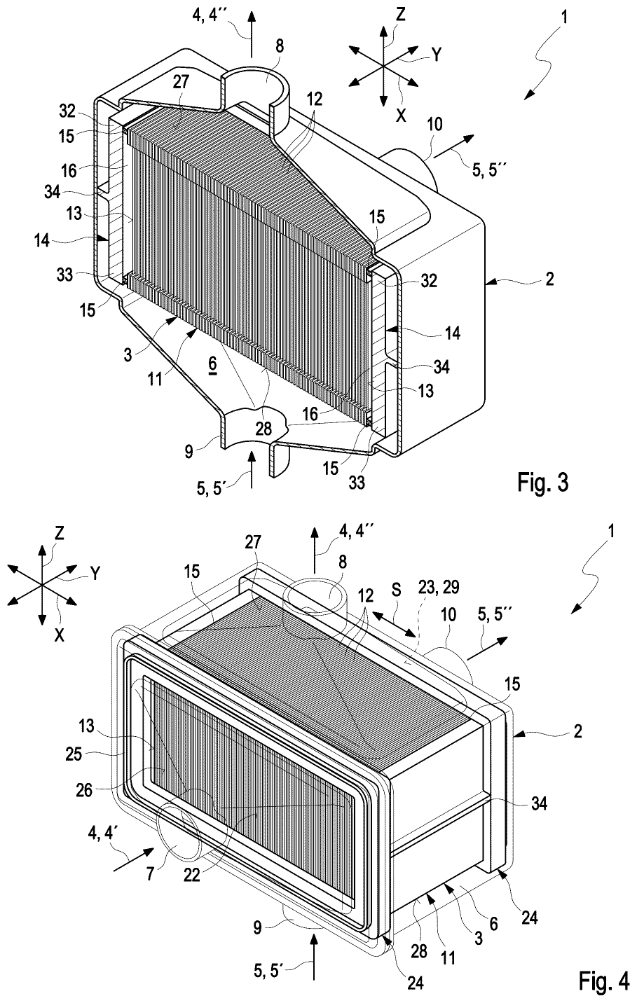

According to FIGS. 3 to 9, 12, and 13, the membrane stack 11 comprises two end faces 13, which face one another in the lengthwise direction of the block X or face away from one another in the lengthwise direction of the block X. The humidifier block 3 comprises two end plates 14 that are respectively mapped to one of the end faces 13 and are respectively arranged on one of the two end faces 13. The respective end plate 14 is braced by at least one seal 15 against the respectively mapped end face 13. The respective seal 15 is adapted to be elastic and is elastically preloaded in the lengthwise direction of the block X. In the embodiments shown here, two such seals 15 are provided on the respective end plate 14. In particular, the seals extend parallel to the transverse direction of the block Y and are spaced apart at the respective end plate 14 in the height direction of the block Z.

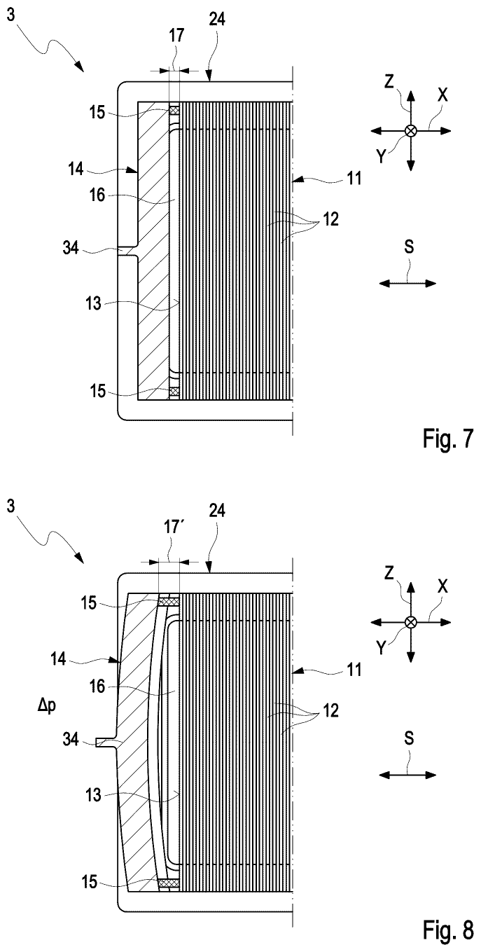

The respective end plate 14 is in contact with the associated end face 13 by the respective seal 15. The respective end plate 14 is otherwise positioned spaced apart from the associated end face 13. According to FIGS. 7 to 9, this creates a cavity 16 that can be used for incident fresh air or exhaust air, and the fresh air flow 4 or the exhaust air flow 5 accordingly flows through said cavity 16 when the humidifier 1 is in operation.

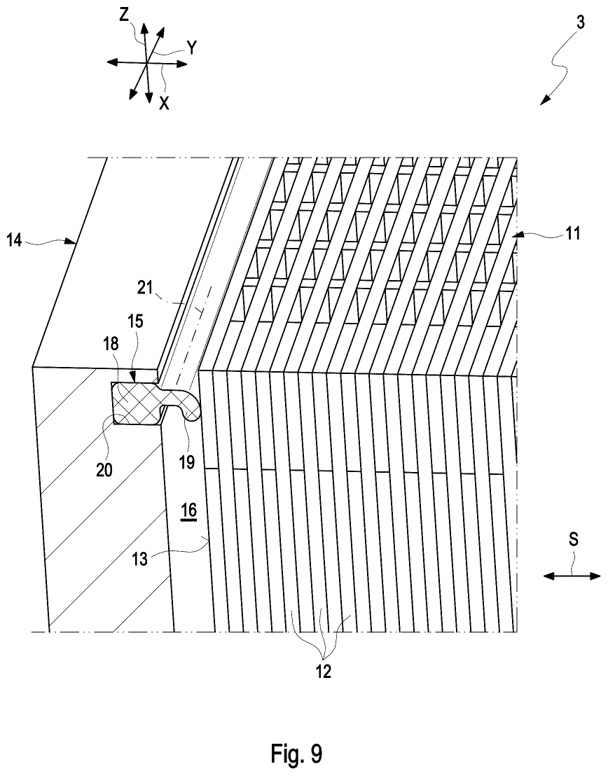

When the humidifier 1 is in operation, a differential pressure Δp can form in the housing 2 between the fresh air flow 4 and the exhaust air flow 5, which, according to FIGS. 6 and 8, can lead to elastic deformation, in particular to an elongation or a compression, of the respective end plate 14. According to FIGS. 5 to 8, the respective end plate 14 has a distance 17 from the respective end face 13 with respect to the lengthwise direction of the block X, said distance 17 being present in the absence of differential pressure Δp and becoming larger or smaller when differential pressure Δp is applied. FIGS. 6 and 8 show an elongation deformation of the end plate 14, wherein the end plate 14 bulges outward. The result is an increased distance 17′. The alternative, wherein a compression deformation of the end plate 14 occurs, wherein the end plate 14 bulges inward, results in a reduced distance 17″ (not shown here). The maximum increase or maximum decrease of the distance 17 is generated in a section of the end plate 14 located centrally with respect to the transverse direction of the block Y. Accordingly, the distance 17 is larger or smaller by an unspecified elongation dimension or compression dimension when differential pressure Δp is applied than in the absence of differential pressure Ap. In other words, the elongation dimension or compression dimension represents the difference between the larger distance 17′ or smaller distance 17″ present when differential pressure Δp is applied and the distance 17 present when differential pressure Δp is absent. The increased distance 17′ and the decreased distance 17″ are not necessarily the same in terms of amount.

In a fully relaxed state, i.e., in particular in an uninstalled state not shown here, the seal 15 is now adapted to be greater in the lengthwise direction of the block X by an unspecified preload dimension than in a preloaded installed state, as for example shown in FIGS. 5 and 7, wherein the seal 15 bridges the distance 17 between the respective end plate 14 and the associated end face 13 in the absence of differential pressure Ap. The preload dimension of the seal is expediently greater than the elongation dimension of the respective end plate 14. In other words, the seal 15 can autonomously extend further in the lengthwise direction of the block X due to its elasticity than the maximum increase of the distance 17 expected due to the deformation of the end plate 14 induced by the pressure difference Ap. This ensures that the correspondingly increased distance 17 or 17′ can still be reliably bridged by the seal 15 even when the maximum expected deformation of the end plate 14 occurs. FIG. 6 clearly shows how the elasticity of the seal 15 can reliably bridge the distance 17 that varies along the transverse direction of the block Y.

According to the examples of FIGS. 3 to 8, the seal 15 can be adapted as an I-seal. Such an I-seal has an elongated cross-section that is with respect to its lengthwise direction aligned parallel to the direction of action of the seal 15. In the examples shown here, the seal 15 acts in the lengthwise direction of the block X and is therefore with its lengthwise direction aligned parallel to the lengthwise direction of the block X. This achieves that the respective seal 15 can be compressed to achieve the preload of the seal 15 in the lengthwise direction of the block X.

By contrast, FIG. 9 shows an embodiment wherein the seal 15 is adapted as a lip seal. The lip seal has a holding foot 18 as well as a seal contour 19. In the example of FIG. 9, the holding foot 18 is held against the respective end plate 14. For example, the holding foot 18 can be inserted into a receiving groove 20, which is for this purpose embodied on the end plate 14 on an inner side facing the associated end face 13. The seal contour 19 abuts the end face 13. In an alternative design, the holding foot 18 can also be held on the end face 13, whereas the seal contour 19 abuts the end plate 14. However, the embodiment shown here is preferred. The preload of the seal 15 in the lengthwise direction of the block X is generated in that the seal 15 is elastically deformed by bending about a bending axis 21 extending transversely to the lengthwise direction of the block X. In the example of FIG. 9, the bending axis 21 extends parallel to the transverse direction of the block Y. In the embodiment shown in FIG. 9, the seal 15 is also arranged such that the differential pressure Δp, which is present between the fresh air flow 4 and the exhaust air flow 5 when the humidifier is in operation 1, increases or decreases the preloaded abutment of the seal 15 on the end face 13. For example, according to FIG. 9, the differential pressure Δp can preferably abut the seal 15 such that there is an overpressure in the cavity 16. As a result, the seal contour 19 is pressed against the end face 13.

In the embodiment shown in FIG. 9, the seal 15 can be adhesive-bonded to the end plate 14 in the region of the holding foot 18. However, such adhesive-bonding is optional. On the other hand, the seal 15 abuts loosely on the end face 13 in the region of the seal contour 19.

On the other hand, the embodiments shown in FIGS. 3 to 8, 12, and 13 can provide that the seal 15 is held, in particular adhesive-bonded, on the end plate 14 and abuts loosely on the end face 13. A reverse design is also conceivable, wherein the seal 15 is held, in particular adhesive-bonded, on the end face 13 while loosely abutting the end plate 14. It is likewise conceivable to hold, or glue, the seal 15 on the end plate 14 and also on the end face 13.

According to FIGS. 2 to 4 and 11 to 13, the membrane stack 11 has two sides 22, 23 that face away from one another transversely to the lengthwise direction of block X. In the examples shown here, the two sides 22, 23 face away from one another in the transverse direction of the block Y. The humidifier block 3 now has respectively one sealing frame 24 on each of said two sides 22, 23. The respective sealing frame 24 is arranged circumferentially closed along the perimeter on the respective side 22, 23. The respective sealing frame 24 braces the humidifier block 11 against the housing 2 on the respective side 22, 23 to form a seal. The embodiments shown here also provide that the respective sealing frame 24 is adapted to also enclose the two end plates 14 on the respective side 22, 23. The respective sealing frame 24 therefore extends along the outer circumference of the humidifier block 3 while also extending along the exterior of the end plates 14. The circumferential direction of the sealing frame 24 in this case revolves about an axis extending parallel to the transverse direction of the block Y.

According to FIGS. 2 and 4, as well as 11 and 13, the respective seal frame 24 can comprise a circumferential side seal 25. The respective seal frame 24 is braced by the respective side seal 25 against the housing 2 to form a seal.

According to FIGS. 2 to 4 and 11 to 13, the membrane stack 11 has a fresh air inlet side 26 fluidically connected to the fresh air inlet 7, a fresh air outlet side 27 fluidically connected to the fresh air outlet 8, an exhaust air inlet side 28 fluidically connected to the exhaust air inlet 9, and an exhaust air outlet side 29 fluidically connected to the exhaust air outlet 10. According to FIGS. 2 and 11, a fresh air path 30 is formed in the membrane stack 11, which fresh air path 30 fluidically connects the fresh air inlet side 26 to the fresh air outlet side 27, and an exhaust air path 31 is formed in the membrane stack 11, which exhaust air path 31 fluidically connects the exhaust air inlet side 28 to the exhaust air outlet side 29.

In the one or first embodiment shown in FIGS. 1 to 4, the fresh air inlet side 26 and the exhaust air outlet side 29 are located opposite to one another with respect to the transverse direction of the block Y. The exhaust air inlet side 28 and the fresh air outlet side 27 are located opposite to one another with respect to the height direction of the block Z. In the embodiment shown here, the two sealing frames 24 are therefore located on the fresh air inlet side 26 and on the exhaust air outlet side 29, which thus form the above-mentioned sides 22 and 23 that are located opposite to one another transverse to the lengthwise direction of the block X.

By contrast, in the other or second embodiment shown in FIGS. 10 to 13, the fresh air inlet side 26 and the fresh air outlet side 27 are located opposite to one another with respect to the transverse direction of the block Y. The exhaust air inlet side 28 and the exhaust air outlet side 29 are located opposite to one another with respect to the height direction of the block Z. In the other embodiment shown here, the two sealing frames 24 are therefore located on the fresh air inlet side 26 and on the fresh air outlet side 27, which thus form the above-mentioned sides 22 and 23 that are located opposite to one another transverse to the lengthwise direction of the block X.

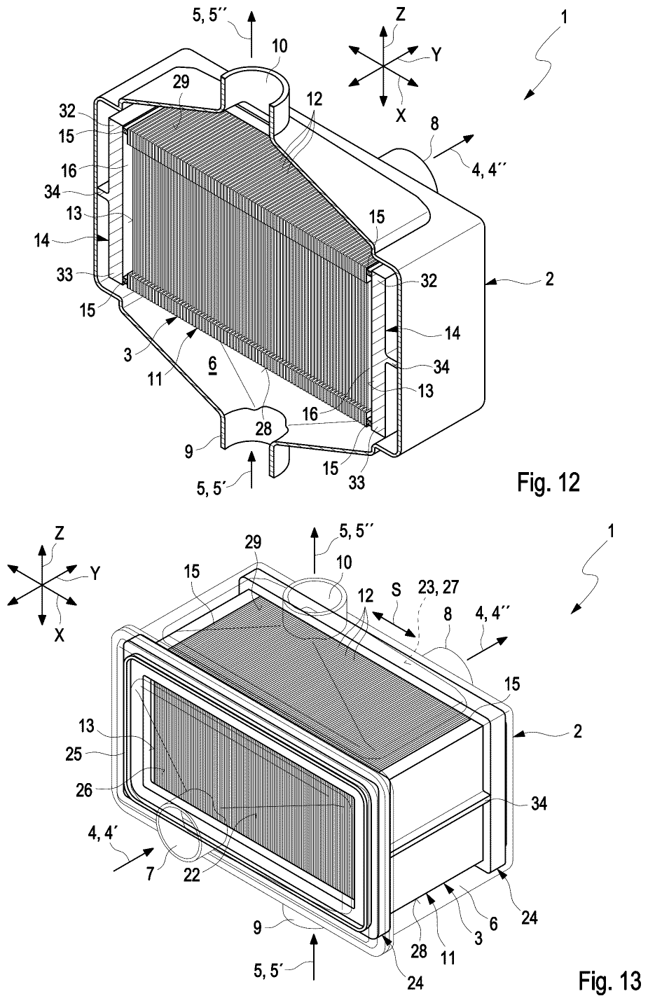

As can be seen in particular from FIGS. 3 and 12, the respective end plate 14 has two end regions 32, 33 facing away from one another in the height direction of the block Z. In FIGS. 3 and 12, an upper end region 32 and a lower end region 33 can be seen on the respective end plate 14. The respective end plate 14 is then braced by two seals 15 of the type described above against the associated end face 13, wherein the respective seal 15 is elastically preloaded in the lengthwise direction of the block X. The two seals 15 are respectively arranged on the respective end plate 14 at one of the two end regions 32, 33 and are respectively adapted to extend lengthwise in the transverse direction of the block Y. Furthermore, the seals 15 respectively preferably extend continuously from the one seal frame 24 in the transverse direction of the block Y to the other seal frame 24. As a result, the two seals 15 delimit the cavity 16 formed in the lengthwise direction of the block X between the respective end plate 14 and the associated end face 13 in the height direction of the block Z.

According to FIGS. 3, 4, 12, and 13, the respective end plate 14 can on an outer side facing away from the membrane stack 11 have at least one rib 34 that extends transversely to the lengthwise direction of the block X by means of which the respective end plate 14 is braced against the housing 2. In the examples, the respective rib 34 extends in a straight line and parallel to the transverse direction of the block Y. The respective rib 34 can in this case be embedded in the sealing frames 24. For example, the sealing frames 24 can be sprayed or foamed onto the membrane stack 11 and the two end plates 14.

1. A humidifier for humidifying dry fresh air using humid exhaust air, comprising:
a housing enclosing a housing interior, the housing including:
a fresh air inlet for supplying dry fresh air;
a fresh air outlet for evacuating humidified fresh air;
an exhaust air inlet for supplying humid exhaust air; and
an exhaust air outlet for evacuating dehumidified exhaust air;
a humidifier block disposed in the housing interior, the humidifier block including a membrane stack through which a fresh air flow and an exhaust air flow are flowable for humidifying the dry fresh air via the humid exhaust air, the membrane stack including a plurality of membranes impermeable to air and permeable to moisture;
the membrane stack having two end faces located opposite one another in a lengthwise direction of the humidifier block;
wherein the humidifier block further includes two end plates that are respectively arranged on a respective end face of the two end faces of the membrane stack; and
wherein each end plate of the two end plates is braced against the respective end face via at least one elastic seal preloaded in the lengthwise direction of the humidifier block.

2. The humidifier according to claim 1, wherein:
a differential pressure is present in the housing between the fresh air flow and the exhaust air flow during operation;
each end plate of the two end plates has a distance from the respective end face in the lengthwise direction of the humidifier block that is i) larger by an elongation dimension when the differential pressure is present and/or ii) smaller by a compression dimension when the differential pressure is not present;
the at least one seal is larger in the lengthwise direction of the humidifier block by a preload dimension when the at least one seal is in a relaxed state than when the at least one seal is in a preloaded installed state such that the at least one seal bridges the distance between the respective end plate and the respective end face when the differential pressure is not present; and
the preload dimension of the at least one seal is greater than the elongation dimension of the respective end plate.

3. The humidifier according to claim 1, wherein:
the at least one seal is an I-seal having a lengthwise direction and an elongated cross section that is oriented parallel to the lengthwise direction of the humidifier block with respect to the lengthwise direction of the at least one seal; and
the at least one seal is preloaded in the lengthwise direction of the humidifier block via being compressed in the lengthwise direction of the humidifier block.

4. The humidifier according to claim 1, wherein:
the at least one seal is a lip seal including:
a holding foot held on the respective end plate and/or the respective end face; and
a sealing contour abutting the respective end face and/or the respective end plate;
and
the at least one seal is preloaded in the lengthwise direction of the humidifier block by being elastically deformed by bending about a bending axis extending transversely to the lengthwise direction of the humidifier block.

5. The humidifier according to claim 4, wherein the at least one seal is arranged such that a differential pressure between the fresh air flow and the exhaust air flow increases and/or decreases a preloaded abutment of the at least one seal on the respective end face and/or on the respective end plate.

6. The humidifier according to claim 1, wherein the at least one seal is adhesive-bonded to the respective end plate and to the respective end face.

7. The humidifier according to claim 1, wherein
the at least one seal is held on the respective end plate and loosely abuts the respective end face; or
the at least one seal is held on the respective end face and loosely abuts the respective end plate.

8. The humidifier according to claim 1, wherein:
the membrane stack has two sides facing away from one another transverse to the lengthwise direction of the humidifier block;
the humidifier block further includes a plurality of sealing frames, each sealing frame of the plurality of sealing frames arranged on a respective side of the two sides of the membrane stack in a circumferentially closed manner along a perimeter and bracing the humidifier block against the housing forming a seal; and
each of the plurality of sealing frames encloses the two end plates on the respective side.

9. The humidifier according to claim 8, wherein each sealing frame of the plurality of sealing frames includes a circumferential side seal via which the sealing frame is braced against the housing to form the seal.

10. The humidifier according to claim 1, wherein:
the membrane stack further includes:
a fresh air inlet side fluidically connected to the fresh air inlet;
a fresh air outlet side fluidically connected to the fresh air outlet;
an exhaust air inlet side fluidically connected to the exhaust air inlet; and
an exhaust air outlet side fluidically connected to the exhaust air outlet;
a fresh air path that fluidically connects the fresh air inlet side to the fresh air outlet side is formed in the membrane stack;
an exhaust air path that fluidically connects the exhaust air inlet side to the exhaust air outlet side is formed in the membrane stack;
the fresh air inlet side and the fresh air outlet side are disposed opposite one another with respect to a transverse direction of the humidifier block extending transversely to the lengthwise direction of the humidifier block; and
the exhaust air inlet side and the exhaust air outlet side are disposed opposite one another with respect to a height direction of the humidifier block extending transversely to the lengthwise direction of the humidifier block and transversely to the transverse direction of the humidifier block.

11. The humidifier according to claim 10, wherein:
each of the two end plates includes two end regions facing away from one another in the height direction of the humidifier block;
the at least one seal includes two elastic seals that are respectively preloaded in the lengthwise direction of the humidifier block; and
the two seals are each arranged on the respective end plate at one of the two end regions and extend lengthwise in the transverse direction of the humidifier block.

12. The humidifier according to claim 10, wherein:
the humidifier block further includes a plurality of sealing frames, each sealing frame of the plurality of sealing frames arranged on a respective side of the membrane stack in a circumferentially closed manner along a perimeter and bracing the humidifier block against the housing forming a seal;
each of the plurality of sealing frames encloses the two end plates on the respective side;
a first sealing frame of the plurality of sealing frames is arranged on the fresh air inlet side; and
a second sealing frame of the plurality of sealing frames is arranged on the fresh air outlet side.

13. The humidifier according to claim 1, wherein the plurality of membranes are stacked against one another in the membrane stack in the lengthwise direction of the humidifier block.

14. The humidifier according to claim 1, wherein the membrane stack is a cuboid shape.

15. The humidifier according to claim 1, wherein each of the two end plates includes at least one protruding rib on an outer side facing away from the membrane stack, the at least one rib braced against the housing and extending transversely to the lengthwise direction of the humidifier block.

16. The humidifier according to claim 11, wherein:
the humidifier block further includes a plurality of sealing frames, each sealing frame of the plurality of sealing frames arranged on a respective side of the membrane stack in a circumferentially closed manner along a perimeter and bracing the humidifier block against the housing forming a seal;
each of the plurality of sealing frames encloses the two end plates on the respective side;
a first sealing frame of the plurality of sealing frames is arranged on the fresh air inlet side; and
a second sealing frame of the plurality of sealing frames is arranged on the fresh air outlet side.

17. The humidifier according to claim 16, wherein each sealing frame of the plurality of sealing frames includes a circumferential side seal via which the sealing frame is braced against the housing to form the seal.

18. The humidifier according to claim 1, wherein:
a differential pressure is present in the housing between the fresh air flow and the exhaust air flow during operation; and
each end plate of the two end plates has a distance from the respective end face in the lengthwise direction of the humidifier block that is i) larger by an elongation dimension when the differential pressure is present and ii) smaller by a compression dimension when the differential pressure is not present.

19. The humidifier according to claim 1, wherein the at least one seal is larger in the lengthwise direction of the humidifier block by a preload dimension when the at least one seal is in a relaxed state than when the at least one seal is in a preloaded installed state such that the at least one seal extends from the respective end plate to the respective end face when a differential pressure is not present in the housing.

20. The humidifier according to claim 1, wherein the at least one seal is elastically deformed about a bending axis extending transversely to the lengthwise direction of the humidifier block such that that the at least one seal is preloaded in the lengthwise direction of the humidifier block.
